(19) United States
(12) Patent Application Publication
(10) Pub. No.: US 2026/0043515 A1
(43) Pub. Date: Feb. 12, 2026

(54) SAFETY MOUNT SYSTEM

(71) Applicant: Balco Global Limited, Chippenahm (GB)

(72) Inventors: Brendan POCOCK, Chippenham (GB); Reuben POCOCK, Chippenham (GB)

(21) Appl. No.: 18/872,358

(22) PCT Filed: Jun. 7, 2023
(86) PCT No.: PCT/IB2023/055900

§ 371 Date: Dec. 6, 2024

(30) Foreign Application Priority Data
Jun. 7, 2022 (GB) 2208358.8

(51) Int. Cl. F16M 13/02

(52) U.S. Cl. CPC F16M 13/02

(57) ABSTRACT

A mounting system for releasably securing an object to a walled surface is described. The system comprises at least one magnetic element; a magnetic counterpart coupled to the object and configured to magnetically engage with the at least one magnetic element; and a mounting plate having attachment means for securing the plate to the walled surface. The mounting plate comprises an exterior surface for releasably securing the object thereto; an interior surface for securing to the walled surface; an indentation in the exterior surface for receiving the counterpart; and one or more recesses in the interior surface, said recesses contained at least partially within the boundary of the indentation on the exterior surface. The at least one magnetic elements are located within the recesses and the counterpart is coupled to the object to magnetically attach the object flush to the mounting plate when the counterpart is received in the indentation.

### FIELD OF INVENTION

The present invention relates to safety mountings and in particular a safety mounting providing a re-useable breakaway joint for use in suspending an article, e.g. a PPE dispenser, toilet roll holder, window curtain rail.

### BACKGROUND OF THE INVENTION

An issue in certain institutions (e.g. Psychiatric wards, Prisons, Hospitals) is the increasing number of persons attempting suicide by ligature from a fixed point, by suspended articles, e.g., a curtain bracket or other mounted holder. Whilst various attempts have been made to mitigate this risk, broadly all solutions provide a breakaway portion that detaches the item from the mount to prevent use of the mounted item as a ligature point. However, a consequential issue of various inventions is that the breakaway portion becomes a weapons risk.

A known safety joint addressing this problem is disclosed in GB2308406 where a plug and socket joint is provided with a load responsive retaining means that the plug releases at a predetermined load. A disadvantage of this solution is that the load not only diminishes over time, but also that a readily available foreign object (e.g. blue tack or chewing gum) can be used to compromise the load release. A further issue with a fixed predetermined weight load is that any fluctuations in desired breakaway force cannot be accounted for.

A further known safety mount is disclosed in GB2351758, with similar magnetic properties, providing ‘fail-safe’ detachment at a predetermined load. A disadvantage of this known safety mount is that the magnet is exposed, leaving a joint around the magnet which is prone to tampering and gaining a horizontal lip with which to attempt a ligature.

Another known safety mount is available which provides a planar surface with which to attach an object (e.g. a towel dispenser). This is attached using magnets from the said system disclosed on GB2351758. A disadvantage of this existing invention is that the said planar surface—typically made of polycarbonate, with a tapered edge on all sides—becomes a heavy weapon with axe-like properties when detached.

The present invention aims to at least ameliorate the above mentioned issues.

### SUMMARY OF THE INVENTION

According to a first aspect of the present invention there is provided a mounting system for releasably securing an object to a walled surface, said system comprising: at least one magnetic element with corresponding counterpart; a mounting plate having attachment means for securing the plate to the walled surface, said mounting plate comprising: an exterior surface for releasably securing the object thereto; an interior surface for securing to the walled surface; an indentation in the exterior surface for receiving the counterpart; and one or more recesses in the interior surface, said recesses substantially contained within the border of the indentation; and wherein the at least one magnetic elements are located within the recesses and further wherein the counterpart is coupled to the object to magnetically attach the object flush to the mounting plate when the counterpart is received in the indentation.

The present system provides a mounting system for attaching one or more objects, such as PPE dispensers, curtain rails, toilet roll holders and the like. If force is applied to the object that is higher than the magnetic attraction holding the object to the exterior surface, the object is released from the mounting plate due to the counterpart disengaging with the magnetic element as it disengages the indentation. This ensures that the mounted object does not pose a ligature risk when used within secure facilities having patients and/or inmates having a ligature risk.

By attaching the object flush to the mounting plate it is intended to mean that the object secured by the counterpart lies substantially flat against the mounting.

For example, in an eating disorder unit where patients are typically lower weight, a lower breakaway force would be desirable. Conversely, if a heavy object is to be attached, such as COVID aprons, a higher breakaway force is desirable to counteract the weight of the static load. If a setting is multi-purpose, or the application of a point is changeable, it is desirable for a variety of predetermined breakaway loads to be used. The use of a single counterpart allows for secure attachment of the object whether one, two, three of more magnetic elements are used, with the attachment force spread across the surface area of the counterpart. The many-to-one configuration allows for a variety of breakaway weights within a setting, and the possibility of changing the breakaway weight by introducing or removing magnetic elements from the underside of the backing plate whilst still using a consistent counterpart. Similarly, by arranging the magnetic elements as desired, the direction of breakaway forces can be chosen to suit the intended purpose. For example, certain items may require a low downward force to overcome the magnetic attachment force (e.g. ones that may pose a ligature risk), whilst others may require a low lateral or sideways force.

The mounting plate may include a plurality of recesses to correspond to a single indentation. This carries through to the use of a plurality of magnetic elements for magnetically securing a single counterpart. This many-to-one arrangement allows for a variable breakaway load as discussed above, and a variety of combinations dependent on the orientation of the object to be mounted. Similarly, this allows a larger counterpart to be used, which mitigates ingestion risk and can also aid in preventing removal of the counterpart from the object. These are important aspects in mental health settings, where smaller counterparts may be ingested and wherein the counterpart may be used as a potential weapon or self-harm tool.

In an embodiment the indentation may be unitary with the exterior surface to form an unbroken exterior surface. This allows for a smooth surface for the mounting plate, which reduces infection risk due to ease of cleaning. Similarly, by providing for a flush engagement between the object and the mounting plate, due to the fit between the counterpart and the correspondingly shaped indentation, there are less crevices in which dirt may accumulate.

Preferably the recesses may be shallower than the thickness of the mounting plate to encapsulate the magnetic elements within the mounting plate. Additionally, by housing magnetic elements behind the exterior surface it is more difficult for these to be extracted from the system for malicious use by an inmate, patient, or prisoner. A patient may attempt to remove and swallow the magnetic elements, or use them to disrupt door entry and patient safety systems. Concealing the magnetic elements reduces the risk of these incidents occurring. Advantageously, this also provides improved infection control: there are fewer surfaces that are exposed and accessible and so less cleaning is necessary. Similarly, the use of a large single counterpart with multiple magnets helps to obfuscate the location of the magnets within the mounting plate, further reducing the risk of someone extracting them from within the mounting plate.

In one embodiment the recesses may not be visible from the exterior surface. Similarly, the at least one magnetic element may be embedded within the mounting plate. This advantageously reduces the risk of the recesses/magnetic elements being targeted by the patient/inmate.

The counterpart and corresponding indentation may be substantially oval-shaped. This advantageously lends itself to a many-to-one configuration with the magnetic elements. Further advantageously, an oval shape has no straight edges that could be used as a ligature point or the basis for blunt weapon. Yet further advantageously, a substantially oval shape lends itself to detachment both vertically and horizontally—and so there is not an angle at which a force exceeding the breakaway load could be applied with the mounted object remaining in place.

Typically, the mounting plate is a plastics material. This allows for ease of cleaning and is magnetically permeable for the at least one magnetic element to allow objects to be magnetically affixed through the mounting plate. The counterpart is typically metallic, but may have a plasticized coating or the like.

In some embodiments the mounting plate may comprise a smooth front face profile, and wherein edges of the front face profile may be angled to avoid ligature points. By angled it is intended to include chamfered surfaces angling the exterior surface towards any surfaces, to aid having a flush surface when the mounting plate is attached to a walled surface. The edges of the indentation and counterpart may also be angled, to avoid ligature points and improve infection control.

Typically the counterpart may comprise a ferromagnetic material for magnetic coupling to the magnetic elements, and the counterpart may further comprise a contoured lower surface shaped to juxtapose with the indentations and a flat top surface to form a co-planar surface with the exterior surface. Typically the flat top surface comprises attachment means for coupling the counterpart to the object, and said attachment means may comprise a countersink for coupling the counterpart flush against the object. The flat top surface may also comprise a lug covering capping the ferromagnetic material to protect the material and prevent tampering.

Typically the magnetic elements are permanent magnets. These provide a tailorable magnetic attachment strength and a more secure and cheaper attachment.

In embodiments a plurality of magnetic elements may be provided, said elements being spaced to allow mounting of the object in one orientation only. In an example, a plurality of magnetic elements may be provided, said elements being spaced to allow mounting of the object via correspondingly spaced magnetic counterpart elements of the object in one orientation only. The spacing may be irregular or may be arranged in a pattern such that only objects having counterparts arranged in the same manner can be affixed to the exterior surface. The spacing may be selected to provide for horizontal or vertical mounting. It may also be appreciated that multiple arrangements may be provided in a single mounting plate, with each arrangement configured to match with a specific object. This can allow different shaped objects to be secured to a single mounting system without providing too high a magnetic force.

As an example, an attachment force of the magnetic mounting may be configured to be weaker than 250 Newtons to allow the object to be easily released from the exterior surface. As discussed, the magnetic mounting force may be weaker in one direction than in other directions.

Typically the counterpart comprises magnetic material, for magnetic securing to the magnetic element—such magnetic material may include ferromagnetic materials, such as magnetic stainless steel.

The counterpart may be countersunk within countersink indentations in the object. The countersink indentations may provide a continuous surface, such as with curved surface on outer edges, that aids cleaning when compared to holes or the like. The counterpart may secured within the countersink indentations by a rivet.

A lug covering may be used with said attachment means to provide a flat surface for mounting the object flush to the exterior surface of the mounting plate. These also ensure that the attachment means are never exposed for infection control purposes.

The mounting plate may be made of either moulded or machined plastics material.

According to second aspect of the present invention there is provided a mounted object for releasable attachment to a walled surface, said walled surface comprising a mounting system according to any embodiment of the first aspect, and the object further being secured to the counterpart for magnetically securing the object to the mounting plate via the at least one magnetic elements.

These and other aspects of the invention will be apparent from, and elucidated with reference to, the embodiments described hereinafter.

### BRIEF DESCRIPTION OF DRAWINGS

Embodiments will be described, by way of example only, with reference to the drawing, in which:

FIG. 1 illustrates a front side of the mounting system having magnetic elements and a counterpart according to an embodiment of the present invention;

FIG. 2 is a rear view of the mounting system of FIG. 1;

FIG. 3 is a schematic of a mounted object magnetically secured to a walled surface using the mounting surface of FIG. 1.

It should be noted that the Figure is diagrammatic and not drawn to scale. Relative dimensions and proportions of parts of the Figure have been shown exaggerated or reduced in size, for the sake of clarity and convenience in the drawings. The same reference signs are generally used to refer to corresponding or similar feature in modified and different embodiments.

### DETAILED DESCRIPTION

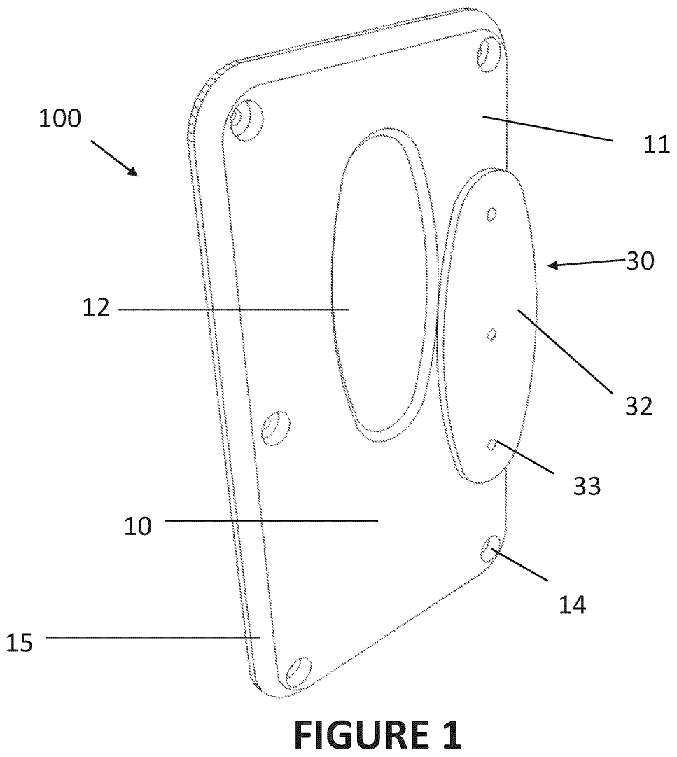

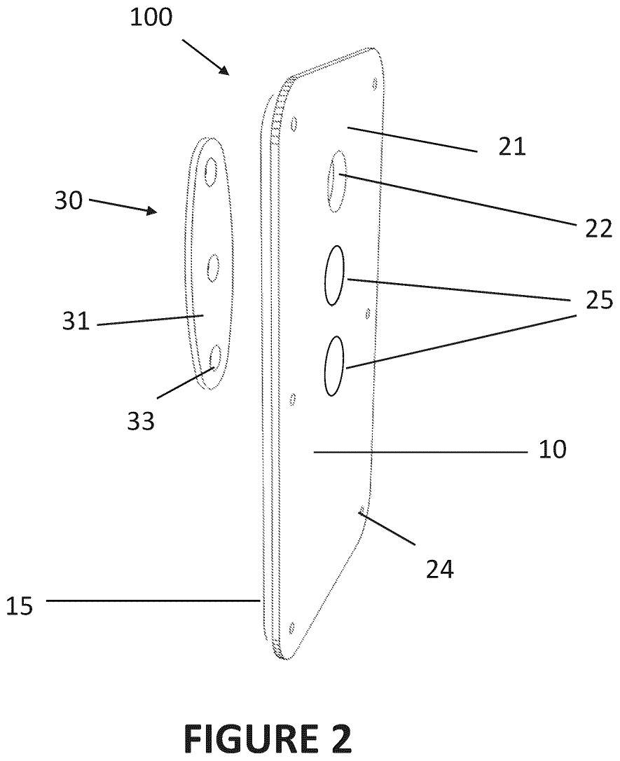

FIGS. 1 and 2 show a schematic of a front side and rear side of a mounting system 100. The mounting system comprises a mounting plate 10 having an exterior surface 11. Within the exterior surface 11 is an indentation 12 that forms a depression on the exterior surface such that the exterior surface is continuous. This aids cleaning and reduces crevices in which bacteria can reside.

The exterior surface forms a solid planar surface that can be tailored to be large enough to mount a desired object, such as a PPE dispenser, toilet roll dispenser, sanitizer dispenser, curtain rail or the like.

The mounting plate comprises attachment means, in the present example holes 14, in which fasteners, such as screws or the like, can be used to secure the mounting plate to a walled surface. The holes 14 are typically countersink holes in which a corresponding fastener can be countersunk. Caps may be used to fill the hole after fixing, said caps or lugs providing a flush surface with the exterior surface to again aid infection control. This also acts to provide an anti-tamper measure to help prevent access to the fastener within the holes, which may be used by inmates or prisoners when the present system is used in a secure facility.

Finally, the mounting plate comprises an outer perimeter. The depth of the outer perimeter may be tailored to allow for the use of deeper indentations or deeper recesses (as will be described below). The outer perimeter is typically angled, in the present example at around 15 degrees, but it can be considered that a greater angle, up to around 45 degrees may be used. The use of such an angled surface is to reduce potential ligature points that could be used to attach a ligature.

FIGS. 1 and 2 further show a counterpart piece 30 that is correspondingly shaped to lie in indentation 12 of the exterior surface. The counterpart is typically magnetic stainless steel for infection control purposes. The counterpart has a curved lower portion 31 (see FIG. 2) configured to fit in a juxtaposed manner into the indentations 12. A flat top portion 32 is provided and allows the counterpart 30 to have a flush fit with the mounting plate 10.

The top portion comprises a plurality of pre-drilled countersink holes 33, to allow fixing of the counterpart by rivet or the like to an object.

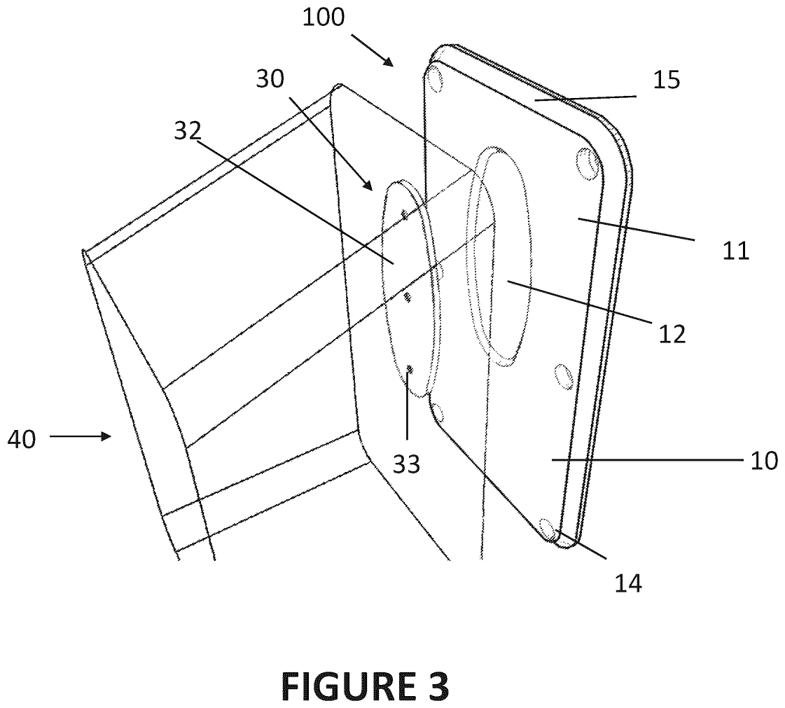

In use, and as seen in FIG. 3, the counterpart 30 is affixed to an object using the countersink holes 33.

FIG. 2 shows the rear of the mounting plate, with an interior surface 21 shown. The corresponding internal holes 24 of the fixing holes 14 are shown. Also shown are a plurality of recesses 22. The recesses are positioned substantially within the boundary of the indentation on the exterior surface and are configured with a depth to not permeate the depth of the mounting plate. Magnet 25, or other magnetic elements, can be placed and housed within the recesses 22. The magnets 25 are typically configured to sit within the recesses 22 and to lie flush or slightly recessed from the interior surface 21.

Although shown as circular, the recesses 22 and the corresponding magnets 25 can be any shape that best suits the mounting plate 10. Additionally, although shown as a single component, the mounting plate may comprise separate components that each provide one of the interior and exterior surfaces 11, 21 and are then interconnected through holes 14 and 24 when affixed to a wall or other surface.

FIG. 3 shows the magnetic securing of the object to the mounting plate 10. The mounting plate 10 receives an object 40 (in this case a PPE dispenser) to which counterpart 30 has been secured.

Prior to installation, the magnets 25 are secured within the recesses 22 using friction, rivets, glue or other means such that the magnets 25 are flush or recessed from the interior surface. It can be appreciated that not all the recesses may be provided with magnets, depending on the weight and size of the object intended to be affixed to the walled surface. This allows the relative magnetic strength at which the object is secured to the object to be tailored according to the desired application. For example, some objects that are secured that require a lower securement force (for example due to light weight of the object) may be secured with a single magnet aligned with the counterpart.

Typically, as shown, a plurality of magnets are used. In the example embodiment shown, 3 magnetic mounting positions 22 are provided, aligned vertically. Due to the corresponding shape of the counterpart 30, the vertically aligned magnets provide for a higher removal force if downward force is applied than if sideways (perpendicular to the vertical alignment of the magnets) force is applied.

The mounting plate 10 is affixed to a walled surface using attachment means (such as antitamper countersunk screws or the like) through holes 14, 24. The mounting plate 10 is fastened to lie flat against the walled surface to minimise ligature points (aided by the angled edge 15).

The counterpart 30 (attached to the object) can then be brought into alignment with the indentation 12 on the exterior surface 11. The magnetic elements then magnetically engage with the counterpart 30 to magnetically secure the object to the mounting plate 10 and accordingly to the walled surface.

The present invention allows for objects to be safely secured to a walled surface such that force applied to the object causes the object to disengage with the walled surface to reduce ligature risk.

From reading the present disclosure, other variations and modifications will be apparent to the skilled person. Such variations and modifications may involve equivalent and other features which are already known in the art of safety door systems, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1. A mounting system for releasably securing an object to a walled surface, said system comprising:
at least one magnetic element;
a magnetic counterpart coupled to the object and configured to magnetically engage with the at least one magnetic element;
a mounting plate having attachment means for securing the plate to the walled surface, said mounting plate comprising:
an exterior surface for releasably securing the object thereto;
an interior surface for securing to the walled surface;
an indentation in the exterior surface for receiving the counterpart; and
one or more recesses in the interior surface, said recesses contained at least partially within the boundary of the indentation on the exterior surface; and
wherein the at least one magnetic elements are located within the recesses and the counterpart is coupled to the object to magnetically attach the object flush to the mounting plate when the counterpart is received in the indentation.

2. The system of claim 1, wherein the indentation is unitary with the exterior surface to form an unbroken exterior surface.

3. The system of claim 1, wherein the counterpart and corresponding indentation are substantially oval shaped.

4. The system of claim 1, wherein the recesses are shallower than the thickness of the mounting plate to encapsulate the magnetic elements within the mounting plate.

5. The system of claim 1, wherein the mounting plate is a plastics material.

6. The system of claim 1, wherein the counterpart comprises a ferromagnetic material for magnetic coupling to the magnetic elements, and the counterpart further comprises a contoured lower surface shaped to juxtapose with the indentation and a flat top surface to form a co-planar surface with the exterior surface.

7. The system of claim 6, wherein the flat top surface comprises attachment means for coupling the counterpart to the object.

8. The system of claim 7, wherein the attachment means comprises a countersink for coupling the counterpart against the object.

9. The system of claim 8, wherein the flat top surface comprises a lug covering the ferromagnetic material.

10. The system of claim 1, wherein the magnetic elements comprise permanent magnets.

11. The system of claim 1, wherein a plurality of magnetic elements are provided, said elements being spaced to allow mounting of the object in one orientation only.

12. The system of claim 1, wherein an attachment force of the magnetic mounting is configured to be weaker than 250 Newtons to allow the object to be easily released from the exterior surface.

13. A mounted object for releasable attachment to a walled surface, said walled surface comprising a mounting system according to claim 1, the object comprising a surface configured to be secured to the counterpart, for magnetically securing the object to the mounting plate via the at least one magnetic elements.
